(19) United States
(12) Patent Application Publication
(10) Pub. No.: US 2022/0184853 A1
(43) Pub. Date: Jun. 16, 2022

(54) BRAIDED PREFORM RADIUS FILLER

(71) Applicant: TEIJIN CARBON EUROPE GMBH, Wuppertal (DE)

(72) Inventors: Martin LINDER, Iserlohn (DE); Julian LOWE, Wuppertal (DE); Ronny WOCKATZ, Höchstadt (DE)

(73) Assignee: TEIJIN CARBON EUROPE GMBH, Wuppertal (DE)

(21) Appl. No.: 17/603,509

(22) PCT Filed: Mar. 16, 2020
(86) PCT No.: PCT/EP2020/057071

§ 371 Date: Oct. 13, 2021

(30) Foreign Application Priority Data
Apr. 18, 2019 (EP) 19170064.0

(51) Int. Cl. B29B 15/12; B29C 70/08; B29C 70/12; B29C 70/22; B29D 99/00

(52) U.S. Cl. CPC B29B 15/125; B29C 70/081; B29K 2105/0827; B29C 70/22; B29D 99/0005; B29C 70/12

(57) ABSTRACT

A braided radius filler, including at least three carbon yarns wherein at least one carbon yarn is a continuous carbon filament yarn and at least two carbon yarns are braided together with each other, wherein at least one continuous carbon filament yarn contains a resin composition in a concentration in the range from 1 to 10 wt. % relative to the fiber weight of the continuous carbon filament yarn and the total amount of resin in the radius filler is less than 10 wt. % relative to the total fiber weight of the radius filler and the braided radius filler is braided according a formula. A further object pertains to a method for producing the radius filler and a composite comprising the radius filler.

The present disclosure relates to a braided preform radius filler for composites structures, a method for producing such braided preform radius filler and a composite containing a braided preform radius filler.

Radius fillers are known and used in a variety of applications. In aircraft construction for example radius fillers are used for the crossovers between different structural parts of elements and they fill up cavities.

In document U.S. Pat. No. 9,827,710 for example a radius filler is described. The radius filler of the patent includes a resin, whereby the resin is added before or after a braiding step. According to FIG. 5 of the above-named document dry fibers be braided and then later wetted in a resin bath or alternatively the fibers be provided as prepreg fibers that be pre-impregnated with resin. Thus, in U.S. Pat. No. 9,827,710 is the amount of resin in the radius high.

In document U.S. Pat. No. 4,650,229 a radius filler comprising unidirectional oriented fibers comprising a stabilizer is disclosed. The fibers shaped in a mold to a shape of a gap.

JP 5984933 corresponds to WO 2013/017434. This document discloses a yarn made of carbon fibers and containing a first and a second resin composition.

Document US 2003/0183067 is directed to a wind tunnel blade. For this device radius fillers are used to fill gaps between different parts of the device. The radius filler comprises a braided sleeve, surrounding a number of unidirectional tows. The braided sleeve comprises a tackifier solution.

It is thus the aim to crates a braided preform radius filler, which overcome the disadvantages of the prior art.

The aim is achieved by a radius filler according to present claim 1.

A filler preform is a three-dimensional dry structure which has nearly the three-dimensional form of the end-product. Thus, it is a preformed product. The preform differs from the end-product in the amount of resin, which is only applied to the preform during the manufacturing process of the end-product. Therefore, a preform is described as a dry structure containing less resin. The term “less resin” means that the total amount of resin within the preform is less than 15 wt. % relative to the total fiber weight of the preform.

The total amount of resin within the entire braided preform radius filler according to the present invention is less than 10 wt. % relative to the total fiber weight of the braided preform radius filler. This means, the fibers of the braided preform radius filler are not impregnated with a resin in the sense of the prior art (neither before nor after a braiding step). However, due to the braiding step the filler keeps its shape without further resin material or sleeves. In addition, the small amount of resin on or in the at least one continuous carbon yarn is suitable to reinforce this effect for the filler.

For the sake of clearness, the braided preform radius filler according to the present disclosure is free of further resins, preparations or matrix material and comprises only less than 10 wt % matrix material relative to the total fiber weight of the braided preform radius filler. Due to that—the braided preform radius filler is light and there is no need for special conditions depending on the matrix or resin material (for example storage condition, lifetime boundaries).

The braided preform radius filler is braided according to the following formula, whereby the braid angle is at least 18°:

braid angle α=arccos((n(cy)*T(cy))/(A(cy)*d(cy)−n(UD)*T(UD))

wherein

n (cy) is the number of carbon yarns,

T (cy) is the titer in tex of the carbon yarns

A (cy) is the cross section of the carbon yarns in mm²

d (cy) is the density of the carbon yarns in g/cm³

n (UD) is the number of unidirectional oriented carbon yarns

T (UD) is the titer of the unidirectional oriented carbon yarns in tex

This kind of braiding in combination with the carbon yarn comprising the resin composition in the claimed range, is suitable to fix the form of the filler in a compact desired way. The filler can be handled easily and is fixable in a gap. On the other hand, the amount of resin is low enough that the filler is flexibly adaptable on the gap and can easily infiltered with matrix in a further processing step. This means, the filler is formable (for example by compression) and can fit the gap accordingly. In addition, the braided preform filler does not or minor influence the mechanical properties of the component comprising the braided preform filler. Thus, the presence of the braided preform filler can be disregarded when calculating the mechanical properties of the component. This is not the case for a filler made of prepregs, rovings or unidirectional fibers.

In one embodiment the braid angle α is in the range of 18° to 50°, 20 to 45°, 25° to 40° or 30 to 35°. The larger the angle, the less the influence of the braided preform filler for the component (comprising the braided preform filler).

In one embodiment the resin composition of the at least one continuous carbon filament yarn in a concentration from 1 to 10 wt. % relative to the fiber weight of the continuous carbon filament yarn is tacky at a temperature over 40° C. In this embodiment the resin composition is non-tacky at ambient temperatures, so that the braiding step can take place without problems. Preferably, the tacky resin composition supports the consolidation of the braided preform radius filler. In this embodiment the consolidation is achieved via the braid and the tacky resin composition due to heating the braid to a temperature over 40° C.

In one embodiment the total amount of resin is a combination of the resin composition and an additional resin composition which may be located on the carbon fiber yarn. In one other embodiment the carbon fiber yarn is free of any additional resin composition and the total amount of resin is the result of the concentration of the resin composition of the continuous carbon filament yarn.

In a preferred embodiment the resin comprises a first resin and a second resin composition, wherein the first resin composition is infiltrated into the at least one continuous carbon filament yarn and the filaments of the at least one continuous carbon filament yarn are at least partially connected via the first resin composition. The second resin composition is on the bundle outer side of the at least one continuous carbon filament yarn in form of particles or drops adhering to the reinforcing fiber filaments of the at least one continuous carbon filament yarn. The first resin composition thereby connects the filaments of the at least one continuous carbon filament yarn at least partially and ensures a very good consolidation. In addition, due to its composition, the first resin composition imparts a high dimensional stability to the braided preform radius filler. The high dimensional stability enables an advantageous embodiment braided preform radius filler. Due to the second resin composition applied to the bundle outer side, it is achieved, that these are non-tacky at ambient temperatures and can be e.g. formed to the braided preform radius filler. At increased temperature, however, a high tackiness is achieved due to the second resin composition, which tackiness also leads to a high stability of the structure of the braided preform radius filler after cooling, even in structures in which the braided yarn is laid to form the radius filler. When using the braided preform radius filler with at least one continuous carbon fiber comprising the first and second resin composition there is no need for an additional binder material for fixing the braided preform radius filler.

In another embodiment the second resin composition is solid at ambient temperatures, is meltable at elevated temperatures and is present on the bundle outer side in a concentration of 0.5 to 10 wt. % in relation to the total weight of the at least one continuous carbon filament yarn. Preferably, the at least 50% of the surface of the bundle outer side of the at least one continuous carbon filament yarn is free of the second resin composition. It was found that the indicated concentration of the second resin composition, in particular the type of application of the second resin composition in the form of particles or drops adhering to the reinforcing fiber filaments of the at least one continuous carbon filament yarn, wherein at least 50% of the surface of the bundle outer side is free of the second resin composition and wherein the bundle interior is free of the second resin composition, leads to yarns with high flexibility and good drapability. It is thereby shown to be advantageous when the particles or drops adhering to the reinforcing fiber filaments have a size less than 300 μm, and particularly advantageous if they have an average size in the range from 20 to 150 μm. Due to this, the braided preform radius filler can be arranged in different cross sectional shapes and also arranged into cavities with different (and pretentious) forms.

In a further embodiment, the first resin composition of the at least one continuous carbon filament yarn of the braided preform radius filler contains at least two bisphenol A epichlorohydrin resins H1 and H2 in a weight ratio H1:H2 of 1.1:1.4. H1 has preferably an epoxy value of 1850 to 2400 mmol/kg and an average molecular weight Mn of 800 to 1000 g/mol and is solid at ambient temperatures. H2 has preferably an epoxy value of 5000 to 5600 mmol/kg and an average molecular weight Mn of <700 g/mol and is liquid at ambient temperatures and the at least one continuous carbon filament yarn has 0.1 to 2 wt. % of the first resin composition in relation to the total weight of the at least one continuous carbon filament yarn. Preferably, the braided preform radius filler has 0.1 to 2 wt. % of the first resin composition in relation to the total weight of the braided preform radius filler.

In a further embodiment the first resin composition further contains an aromatic polyhydroxy ether P1, which has an acid value of 40 to 55 mg KOH/g and an average molecular weight Mn of 4000 to 5000 g/mol. It was found that the dimensional stability of the at least one continuous carbon filament yarn is influenced by the first resin composition, with which the at least one continuous carbon filament yarn is infiltrated, wherein the proportion of the aromatic polyhydroxy ether P1 plays a major role. In a preferred embodiment, the first resin composition thereby contains the bisphenol A epichlorohydrin resins H1 and H2 in a weight ratio to the aromatic polyhydroxy ether P1, (H1+H2):P1, of 0.05 to 0.8. In tests it was observed that weight ratios lower than 0.05 can lead to increased yarn abrasion. Weight ratios greater than 0.8 in contrast lead to yarns with an excessively low dimensional stability. In view of the dimensional stability on the one hand and the drapability on the other hand, it is also advantageous if the first resin composition is present in a concentration of 0.4 to 1.2 wt. % in relation to the total weight of the at least one continuous carbon filament yarn.

Preferably, the second resin composition contains at least 50 wt. % of a bisphenol A epichlorohydrin resin H3 with an epoxy value of 480 to 645 mmol/kg and an average molecular weight Mn of 2700 to 4000 g/mol, an aromatic polyhydroxy ether P2, a polyamide or a thermoplastic polyurethane resin or mixtures of these compounds, wherein the compounds have a melting temperature in the range of 110 to 150° C.

In a further embodiment the braided preform radius filler comprises only carbon yarns made from continuous carbon filaments. In one embodiment all continuous carbon filament yarns exhibit the above described resin composition. In another embodiment the braided perform radius filler comprises also at least one carbon yarn, which is made from short fibers and/or staple fibers (discontinuous fibers). In one embodiment the carbon yarn made from staple or short fibers does not have the resin composition as disclosed above. Thus, the braided preform radius filler is braided via a combination from continuous carbon filament yarn(s) comprising the disclosed resin composition and carbon fiber yarn(s) without such a resin composition.

In one embodiment the braided preform radius filler is made such that the continuous carbon filament yarn(s) comprising the disclosed resin composition is arranged on the outer sheath of the braided preform radius filler and the core of the braided perform radius filler is made from a carbon yarn(s), which is made from short fibers and/or staple fibers without the resin composition. Due to this arrangement the braided preform radius filler can be easily fit the cavity and the droplets of the second resin composition becomes tacky via heating and links to the cavity. Handling of the braided preform radius filler in a composite becomes very easy.

In one further embodiment the braided preform radius filler has the continuous carbon filament yarn(s) comprising the disclosed resin composition in the core region of the braided preform radius filler and the sheath region is made from carbon yarn(s) made from short fibers and/or staple fibers without the resin composition. Such a braided preform radius filler exhibits excellent dimensional stability. Via heating of the braided perform radius filler, the droplets of the second resin composition become tacky and the braided yarn structure is thereby improved even more.

In yet another embodiment the braid preform radius filler comprises continuous carbon filament yarn(s) with resin composition as described above as well as discontinuous carbon yarn(s) (made of staple fibers or short fibers) without resin composition as described and is braided in such a way that the yarns are uniformly arranged in the braided preform radius filler.

However, a braided preform radius filler comprising a combination of continuous carbon filament yarn(s) and carbon yarn(s) made from short fibers and/or staple fibers, wherein all yarns comprises the resin composition are also possible.

In one embodiment the braided preform radius filler has a triangular, square, cylindrical or multi angular cross section shape.

In one embodiment the at least one continuous carbon filament yarn comprises 6000 to 48,000 filaments, has a linear density in the range from 400 to 32,000 tex.

In respect of the continuous carbon filament yarn comprising the above described resin composition reference is made to European patent application EP2736691A1 which is hereby incorporated by reference. Especially the disclosure of the resin composite on page 6 to 15 is incorporated by reference. The reference in respect of the resin composition is also incorporated for the carbon yarn made of short fibers or staple fibers as disclosed

Another embodiment of the present invention is a method for producing the braided preform radius filler according to claim 1. It should be clear that all embodiments disclosed for the braided preform radius filler are also applicable for the method for producing the braided preform radius filler.

A further embodiment of the present invention pertains to a composite comprising the braided preform radius filler according to this disclosure.

1. Braided preform radius filler, comprising at least three carbon yarns wherein at least one carbon yarn is a continuous carbon filament yarn and wherein the at least three carbon yarns are braided together with each other, wherein at least one continuous carbon filament yarn comprises a resin composition in a concentration in the range from 1 to 10 wt. % relative to the fiber weight of the continuous carbon filament yarn and the total amount of resin within the entire braided preform radius filler is less than 10 wt. % relative to the total fiber weight of the braided preform radius filler and the braided preform radius filler comprises only carbon yarns and the braiding step based on the following formula, whereby the braid angle α is at least 18°:
braid angle α=arccos((n(cy)*T(cy))/(A(cy)*d(cy)−n(UD)*T(UD))
wherein
n (cy) is the number of carbon yarns,
T (cy) is the titer in tex of the carbon yarns
A (cy) is the cross section of the carbon yarns in mm²
d (cy) is the density of the carbon yarns in g/cm³
n (UD) is the number of unidirectional oriented carbon yarns
T (UD) is the titer of the unidirectional oriented carbon yarns in tex

2. Braided preform radius filler according to claim 1, wherein the braid angle α is in the range of 20° to 45°.

3. Braided preform radius filler according to claim 1, wherein the resin composition comprises a first resin and a second resin composition, wherein the first resin composition is infiltrated into the at least one continuous carbon filament yarn and the filaments of the at least one continuous carbon filament yarn are at least partially connected via the first resin composition and the second resin composition is on the bundle outer side of the at least one continuous carbon filament yarn in form of particles or drops adhering to the reinforcing fiber filaments of the at least one continuous carbon filament yarn.

4. Braided preform radius filler according to claim 1, wherein all carbon yarns are continuous carbon filament yarns.

5. Braided preform radius filler according to claim 1, wherein at least one carbon yarn is made from short fibers and/or staple fibers.

6. Braided preform radius filler according to claim 1, wherein all carbon yarns contain a resin composition in a concentration in the range from 1 to 10 wt. % relative to the fiber weight of each carbon yarn.

7. Braided preform radius filler according to claim 1, wherein the braided preform radius filler has a triangular, square, cylindrical or multi angular cross section shape.

8. Braided preform radius filler according to claim 3, wherein the first resin composition contains at least two bisphenol A epichlorohydrin resins H1 and H2 in a weight ratio H1:H2 of 1.1 to 1.4, wherein H1 has an epoxy value of 1850 to 2400 mmol/kg and an average molecular weight Mn of 800 to 1000 g/mol and is solid at ambient temperatures, and H2 has an epoxy value of 5000 to 5600 mmol/kg and an average molecular weight Mn of <700 g/mol and is liquid at ambient temperatures and the at least one continuous carbon filament yarn has 0.1 to 2 wt. % of the first resin composition in relation to the total weight of the at least one continuous carbon filament yarn.

9. Braided preform radius filler according to claim 3, wherein the second resin composition contains at least 50 wt. % of a bisphenol A epichlorohydrin resin H3 with an epoxy value of 480 to 645 mmol/kg and an average molecular weight Mn of 2700 to 4000 g/mol, an aromatic polyhydroxy ether P2, a polyamide or a thermoplastic polyurethane resin or mixtures of these compounds, wherein the compounds have a melting temperature in the range of 110 to 150° C.

10. Braided preform radius filler according to claim 3, wherein the second resin composition is solid at ambient temperatures, is meltable at elevated temperatures and is present on the bundle outer side in a concentration of 0.5 to 10 wt. % in relation to the total weight of the at least one continuous carbon filament yarn and wherein at least 50% of the surface of the bundle outer side of the at least one continuous carbon filament yarn is free of the second resin composition.

11. Braided preform radius filler according to claim 3, wherein the bundle interior of the at least one continuous carbon filament yarn is free of the second resin composition.

12. Braided preform radius filler according to claim 3, wherein the bundle interior of the at least three carbon yarns is free of the second resin composition.

13. Braided preform radius filler according to claim 3, wherein the first resin composition further contains an aromatic polyhydroxy ether P1, which has an acid value of 40 to 55 mg KOH/g and an average molecular weight Mn of 4000 to 5000 g/mol.

14. Braided preform radius filler according to claim 1, wherein the at least one continuous carbon filament yarn has 6000 to 48,000 filaments, has a linear density in the range from 400 to 32,000 tex measured according to EN ISO 2060:1995.

15. Method for producing a braided preform radius filler, wherein at least three carbon yarns are braided together according to claim 1, whereby at least one of the at least three carbon yarns is a continuous carbon filament yarn, wherein at least one continuous carbon filament yarn contains a resin composition in a concentration in the range from 1 to 10 wt. % relative to the fiber weight of the continuous carbon filament yarn and the total amount of resin in the radius filler is less than 10 wt. % relative to the total fiber weight of the radius filler.

16. Composite comprising a braided radius filler according to claim 1.
